(19) United States
(12) Patent Application Publication
(10) Pub. No.: US 2022/0109304 A1
(43) Pub. Date: Apr. 7, 2022

(54) METHOD AND APPARATUS FOR MULTI-ENERGY SYSTEM PLANNING BASED ON SECURITY REGION IDENTIFICATION

(71) Applicant: Tsinghua University, Beijing (CN)

(72) Inventors: Pei YONG, Beijing (CN); Ning ZHANG, Beijing (CN); Ershun DU, Beijing (CN); Yi WANG, Beijing (CN); Chongqing KANG, Beijing (CN)

(21) Appl. No.: 17/551,178

(22) Filed: Dec. 14, 2021

Related U.S. Application Data
(63) Continuation of application No. PCT/CN2020/127854, filed on Nov. 10, 2020.

(30) Foreign Application Priority Data
Mar. 17, 2020 (CN) 202010188141.6

(51) Int. Cl. H02J 3/38; H02J 13/00; G05B 17/02

(52) U.S. Cl. CPC H02J 3/381; H02J 2203/20; G05B 17/02; H02J 13/00002

(57) ABSTRACT

A multi-energy system planning method is disclosed based on security region identification. The method includes obtaining alternative planning schemes from a multi-energy system planning department; for each alternative scheme, establishing a matrix model for describing energy conversion relationships in the multi-energy system, in which the multi-energy system comprises N energy conversion elements, N being an integer greater than or equal to 1; identifying N feasible domains of the multi-energy system under N operation scenarios, in which the i-th energy conversion element is out of operating under the i-th operation scenario, and calculating a security region of the multi-energy system by intersecting the identified feasible domains under N operation scenarios; calculating a load fitness rate of each alternative scheme based on each security region; and selecting an alternative scheme with the highest load fitness rate as a target scheme for planning the multi-energy system.

### CROSS REFERENCE TO RELATED APPLICATIONS

This application is a continuation of International Application No. PCT/CN2020/127854, filed on Nov. 10, 2020, which claims priority to Chinese Patent Application No. 202010188141.6, filed on Mar. 17, 2020, the entire disclosures of which are incorporated herein by reference.

### TECHNICAL FIELD

The disclosure relates to a method and an apparatus for planning a multi-energy system based on security region identification, which belongs to the technical field of planning the multi-energy system.

### BACKGROUND

The multi-energy system is an energy system where various energy sources are integrated together, such as a fossil energy source, a renewable energy source, and a biomass energy source. In consideration of each process in an energy utilization cycle such as energy production, conversion, transmission, storage and application, requirements for various energy sources such as cold, heat, and electricity are met at the same time. Because of coordination and complementation between various energy sources, the multi-energy system may effectively improve energy utilization efficiency and reduce carbon emissions. Thus, the multi-energy system is an important direction of the future energy system development.

### SUMMARY

According to a first aspect of the disclosure, a method for planning a multi-energy system based on security region identification includes: obtaining alternative schemes for planning the multi-energy system from a multi-energy system planning department; for each of the alternative schemes, establishing a matrix model for describing energy conversion relationships in the multi-energy system, in which the multi-energy system includes N energy conversion elements, N being an integer greater than or equal to 1, identifying a feasible domain of the multi-energy system under every operation scenario, in which the i-th energy conversion element is out of operating under the i-th operation scenario, and calculating a security region of the multi-energy system by intersecting the identified feasible domains under N operation scenarios; calculating a load fitness rate of each alternative scheme based on each security region; and selecting an alternative scheme with the highest load fitness rate as a target scheme for planning the multi-energy system.

According to a second aspect of the disclosure, an apparatus for planning a multi-energy system based on security region identification includes a processor and a memory having instructions stored thereon and executable by the processor. When the instructions are executed by the processor, the processor is configured to obtain alternative schemes for planning the multi-energy system from a multi-energy system planning department; for each of the alternative schemes, establish a matrix model for describing energy conversion relationships in the multi-energy system, in which the multi-energy system includes N energy conversion elements, N being an integer greater than or equal to 1, identify N feasible domains of the multi-energy system under N operation scenarios, in which the i-th energy conversion element is out of operating under the i-th operation scenario, and calculate a security region of the multi-energy system by intersecting the identified feasible domains under N operation scenarios; calculate a load fitness rate of each alternative scheme based on each security region; and select an alternative scheme with the highest load fitness rate as a target scheme for planning the multi-energy system.

The additional aspects and advantages of the disclosure will be partly given in the following description, and some will become obvious from the following description, or be understood through the practice of the disclosure.

### BRIEF DESCRIPTION OF THE DRAWINGS

FIG. 1 is a flowchart of a method for planning a multi-energy system based on security region identification according to an embodiment of the disclosure.

FIG. 2 is a flowchart of a method for identifying N feasible domains of the multi-energy system under N operation scenarios according to an embodiment of the disclosure.

FIG. 3 is a flowchart of selecting a target planning scheme of the multi-energy system among G alternative schemes according to an embodiment of the disclosure.

FIG. 4 is a structural schematic diagram of an apparatus 50 for planning a multi-energy system based on security region identification according to an embodiment of the disclosure.

### DETAILED DESCRIPTION

Embodiments of the disclosure are described in detail below. Examples of the embodiments are shown in the accompanying drawings, throughout which the same or similar reference numbers indicate the same or similar elements or the elements with the same or similar functions. The embodiments described below with reference to the drawings are exemplary, and are intended to explain the disclosure, but should not be understood as a limitation to the disclosure.

The terms used in the disclosure are only for the purpose of describing specific embodiments, and are not intended to limit the disclosure. The singular forms of “a”, “said” and “the” used in the disclosure and appended claims are also intended to include plural forms, unless the context clearly indicates other meanings. It should be understood that the term “and/or” as used herein refers to and includes any or all possible combinations of one or more associated items listed.

It should be understood that although the terms “first”, “second” and “third” are used in the disclosure to describe various information, the information should not be limited to these terms. These terms are only used to distinguish the same type of information from each other. For example, without departing from the scope of the disclosure, the first information may also be referred to as second information, and similarly, the second information may also be referred to as first information. Depending on the context, the word “if” as used herein is interpreted as “when” or “upon” or “in response to determining”.

In the multi-energy system, the coordination and complementation between various energy sources improves the energy utilization efficiency and effectively promotes the consumption of renewable energy. Since different energy sectors in the multi-energy system are not independent from each other, there are strong constraints between these energy sectors, which makes it impossible to perform a separate security region analysis on each of the energy sectors. However, at the planning level, it is necessary to evaluate the load capacity of each multi-energy system planning scheme by performing the security region analysis, so as to determine an optimal planning multi-energy system scheme. Therefore, there is a need for a multi-energy system planning method in consideration of security region analysis. However, there are some problems in the related art as follows:

1) For conventional power systems, the existing methods for security region analysis in a power system cannot be directly applied to the security region analysis in a multi-energy system.

2) The existing methods for security region analysis in the multi-energy system are all aimed at a specific multi-energy system without universal applicability and portability. Due to a lack of a unified modeling for the security region in the multi-energy system, the existing methods can only analyze the problems case by case.

3) The existing methods for security region analysis in the multi-energy system cannot obtain explicit and analytical expressions on the security region. However, for the multi-energy system planning, it is necessary to embed the explicit and analytical expressions on the security region in the corresponding application operation scenarios.

4) Since it is impossible to obtain unified and analytical analysis results of the security region in the multi-energy system planning process, it is difficult to consider the analysis results of the security region, and the load capacity of the planning results cannot be guaranteed, so that the planning results may lead to defects in some operation scenarios.

At present, there is no method to solve the above problems. In this regard, the disclosure provides a method for planning a multi-energy system based on security region identification.

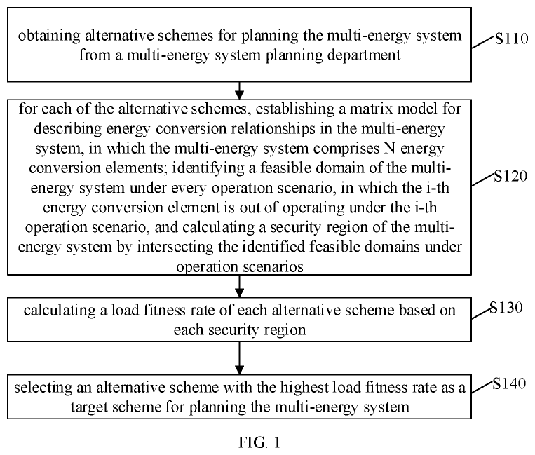

FIG. 1 is a flowchart of a method for planning a multi-energy system based on security region identification according to an embodiment of the disclosure. The method may be executed by an electronic device. As illustrated in FIG. 1, the method includes the following steps at S110-S140.

At S110, alternative schemes for planning the multi-energy system are obtained from a multi-energy system planning department.

In an embodiment, the alternative schemes for planning the multi-energy system may be designed and provided by the specific energy and power department.

At S120, for each of the alternative schemes, a matrix model for describing energy conversion relationships in the multi-energy system is established, N feasible domains of the multi-energy system is identified under N operation scenarios, and a security region of the multi-energy system is calculated by intersecting the identified feasible domains under N operation scenarios. The multi-energy system includes N energy conversion elements, N being an integer greater than or equal to 1. The i-th energy conversion element is out of operating under the i-th operation scenario.

The operation scenario herein refers to a scenario where one of the N energy conversion elements is out of operation. In other words, the i-th element exits the current operation of the multi-energy system while there N−1 elements are operating. Therefore, N feasible domains of the multi-energy system are identified under N operation scenarios.

The multi-energy system also includes M energy transmission channels in total, where M is an integer greater than or equal to 1. Each energy conversion element may be considered as a node. Each energy transmission channel may be considered as a branch. The energy conversion element may have Kᵢ ports, in which the subscript i is a serial number of the energy conversion element. The energy transmission channel is numbered with the subscript b.

The energy conversion relationships may include relationships between different ports, relationships between the port and the connected/disconnected branch, etc.

In an embodiment of the disclosure, the energy conversion relationship matrix model may be established based on an energy conversion relationship matrix of each energy conversion element, an internal energy conversion relationship matrix of the multi-energy system, an input relationship matrix and an output relationship matrix of the multi-energy system.

The energy conversion relationship matrix model is established by the following steps at (1-1) to (1-4).

(1-1) an energy conversion relationship matrix of the i-th energy conversion element is established.

A “port-branch” energy transmission relationship matrix Aᵢ(k,b) of the i-th energy conversion element is established, which represents energy conversion relationships between the ports and branches, and Aᵢ(k,b) is expressed by:

$${A}_{:} ( k , b ) = \{ \begin{matrix}1 an input port k of the element i connected to the branch b \\ - 1 an input port k of the element i connected to the branch b \\ 0 a port k of the element i disconnected to the branch b\end{matrix} .$$

where the dimension of Aᵢ is Kᵢ×M.

A port energy conversion relationship matrix Hᵢ of the i-th energy conversion element is then obtained assuming there are Lᵢ pieces of energy conversion relationships between the different ports of the i-th energy conversion element. The dimension of Hᵢ is Lᵢ×Kᵢ and its each row describes a piece of energy conversion relationship of the i-th energy conversion element.

Then, the energy conversion relationship matrix Zᵢ of the i-th energy conversion element is determined according to the above-mentioned port-branch energy conversion relationship matrix Aᵢ(k,b) and the port energy conversion relationship matrix Hᵢ. The matrix Zᵢ is expressed by:

Zᵢ=Hᵢ×Aᵢ(k,b).

By traversing the N energy conversion elements in the multi-energy system, the energy conversion relationship matrix for each of the N energy conversion elements is obtained through the above establishing process.

(1-2) an internal energy conversion relationship matrix Z of the multi-energy system is established by combining energy conversion relationship matrixes of N energy conversion elements. The internal energy conversion relationship matrix Z is expressed by

Z=[Z₁^{T},Z₂^{T},L,Z_{N}^{T}]^{T},

where the superscript T is a matrix transposition operation.

(1-3) an input relationship matrix and an output relationship matrix of the multi-energy system are established.

Assuming there are P energy input ports and Q load output ports in the multi-energy system, the input relationship matrix Cᵢₙ(p,b) and the output relationship matrix Cₒᵤₜ(q,b) of the multi-energy system are obtained. The dimension of the input relationship matrix is P×M, and the dimension of the output relationship matrix is Q×M.

The value of each element in the matrix Cᵢₙ(p,b) is determined by:

$${C}_{m} ( p , b ) = \{ \begin{matrix}1 & if the input port p is connected to a source end of the branch b \\ 0 & otherwise\end{matrix} ,$$

where the port p is any one of the P energy input port.

The value of each element in the matrix Cₒᵤₜ(q,b) is determined by:

$${C}_{o u t} ( q , b ) = \{ \begin{matrix}1 & if the input port q is connected to a source end of the branch b \\ 0 & otherwise\end{matrix} ,$$

where the port q is any one of the Q load output ports.

(1-4) the energy conversion relationship matrix model of the multi-energy system is calculated from the matrices from (1-1) to (1-3), which is expressed by

ZV=0

CᵢₙV=Vᵢₙ

CₒᵤₜV=Vₒᵤₜ

where V is a state variable of the multi-energy system which represents an energy flow on a branch in the multi-energy system and its dimension is M×1; Vᵢₙ represents an input energy flow of the multi-energy system and its dimension is P×1; Vₒᵤₜ represents an output energy flow of the multi-energy system and its dimension is Q×1.

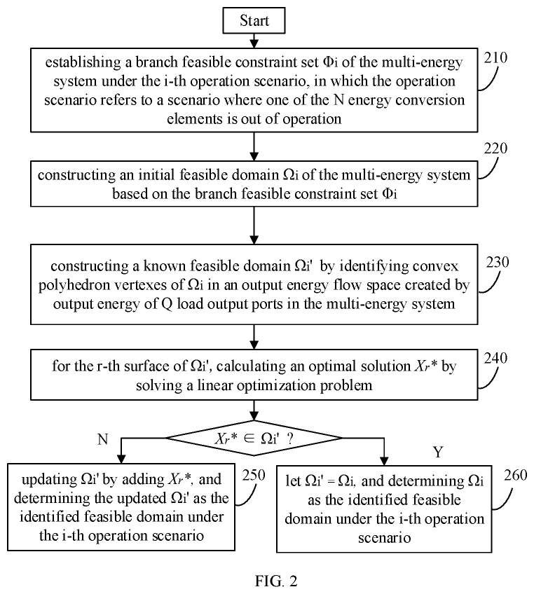

FIG. 2 is a flowchart of a method for identifying the feasible domain of the multi-energy system under every operation scenario according to an embodiment of the disclosure. As illustrated in FIG. 2, N feasible domains of the multi-energy system under N operation scenarios are respectively identified. The method may include the following steps at S210-S260.

At S210, the branch feasible constraint set Φᵢ (i=1,2, . . . , N) of the multi-energy system is established under the i-th operation scenarios. The establishing process may include the following steps at (2-1-1) to (2-1-4).

(2-1-1) the branch feasible constraint set Φᵢ is initialized to an empty set.

(2-1-2) assuming a set of branches Eₖ_{ᵢ} is connected to the Kᵢ ports of the i-th energy conversion element, an equation

$${\sum }_{b ∈ {E}_{{k}_{i}}} {V}_{b} = 0$$

is established for the Kᵢ ports of Eₖ_{ᵢ}, where V_{b} represents an energy flow on the branch b in the multi-energy system, and all the equations are added to the branch feasible constraint set Φᵢ.

(2-1-3) assuming a set of branches Eₖ_{ⱼ} is connected to the kⱼ ports of the j-th energy conversion element (j≠i), an inequation

$${\sum }_{b ∈ {E}_{{k}_{j}}} {V}_{b} \leq {V}_{{k}_{j}}^{max}$$

is established for all ports kⱼ of Eₖ_{ⱼ}, where Vₖ_{ⱼ}^{max} is the maximum capacity of energy flows for the kⱼ ports in the multi-energy system, and all the inequations are added to the branch feasible constraint set Φᵤ in step (2-1-2). By traversing all the energy conversion elements with j≠i, the step (2-1-3) is repeated, so as to obtain the branch feasible constraint set Φᵢ under the i-th operation scenario.

(2-1-4) the steps at (2-1-1) to (2-1-3) are repeated to obtain N branch feasible constraint sets Φᵢ (i=1,2, . . . , N) of the multi-energy system under N operation scenarios.

At S220, an initial feasible domain Ωᵢ of the multi-energy system is constructed under i-th operation scenario based on the branch feasible constraint set Φᵢ. The initial feasible domain is expressed by

Ωᵢ={Vₒᵤₜ|CₒᵤₜV=Vₒᵤₜ,ZV=0,V∈Φᵢ}

where Φᵢ is a branch feasible constraint set under the i-th operation scenario established at S210, V represents the branch energy flow in the multi-energy system at (1-4), Vₒᵤₜ represents the output energy flow of the multi-energy system at (1-4), Z represents the energy conversion relationship matrix of the multi-energy system at (1-4), and Cₒᵤₜ represents the output relationship matrix of the multi-energy system at (1-4).

At 230, a known feasible domain Ωᵢ′ is constructed by identifying convex polyhedron vertexes of Ωᵢ in an output energy flow space. The output energy flow space is created by output energy of Q load output ports in the multi-energy system and its dimension is Q.

The initial feasible domain Ωᵢ of the multi-energy system under the i-th operation scenario is a convex polyhedron in the output energy flow space. The initial feasible domain Ωᵢ at 220 is identified by solving vertexes of the convex polyhedron.

The Q-dimensional rectangular coordinate system with the origin being 0 is established in the output energy flow space. Feasible domain vertexes of Ωᵢ on the coordinate axes in the output energy flow space are first identified to construct a known feasible domain Ωᵢ′. It is assumed that e_{q} is a unit direction vector of the q-th coordinate in the output energy flow space, a linear optimization problem is solved to obtain an optimal solution X_{q}*, which represents a feasible domain vertex on the q-th coordinate axis. The linear optimization problem is expressed by the formula (1).

max e_{q}^{T}X_{q}

s.t. X_{q}=CₒᵤₜV

ZV=0

V∈Φᵢ (1)

The Q coordinate axes are traversed to obtain Q feasible domain vertexes, and the known feasible domain Ωᵢ′ is consisted of Q-vertex set Vert′.

A S240, for the r-th surface of Ωᵢ′, an optimal solution Xᵣ* is calculated by solving a linear optimization problem. The linear optimization problem is expressed by the formula (2).

max dᵣ^{T}Xᵣ

s.t. Xᵣ=CₒᵤₜV

ZV=0

V∈Φᵢ (2)

where dᵣ represents a unit normal vector of the r-th surface in Ωᵢ′ and the superscript T represents a matrix transposition operation.

At 250, in response to Xᵣ* not belonging to Ωᵢ′, Xᵣ* is updated to Ωᵢ′ and the updated Ωᵢ′ is determined as the feasible domain under the i-th operation scenario.

At 260, in response to Xᵣ* belonging to Ωᵢ′, Ωᵢ is determined as the feasible domain under the i-th operation scenario.

In an embodiment, it is judged whether the optimal solution Xᵣ* calculated by the formula (2) belongs to the set Vert′. If the optimal solution Xᵣ* does not belong to the set Vert′, Xᵣ* is added to Vert′; and if the optimal solution Xᵣ* belongs to Vert′, Vert′ is kept unchanged. R surfaces of the known feasible domain Ωᵢ′ are traversed and R calculations are performed by using the formula (2) to obtain R optimal solutions. Then, it is judged whether the R optimal solutions belong to the set Vert′. If Vert′ has not been updated for the R calculations, let Ωᵢ′=Ωᵢ, i.e., Ωᵢ is determined as the feasible domain under the i-th operation scenario. If Vert has been updated in the R calculations, the last updated Vert in is used to form the known feasible domain Ωᵢ′ as the feasible domain under the i-th operation scenario.

For each of N operation scenarios where an energy conversion element is out of operating, the steps at S210-S260 are repeated to obtain the identified feasible domain of the multi-energy system under each operation scenario.

In an embodiment, the N feasible domains of the multi-energy system under the N operation scenarios are intersected to obtain a security region Ω of the multi-energy system using the following formula:

Ω=Ω₁∩Ω₂∩L∩Ω_{N}.

At S130, a load fitness rate of each alternative scheme is calculated based on each security region.

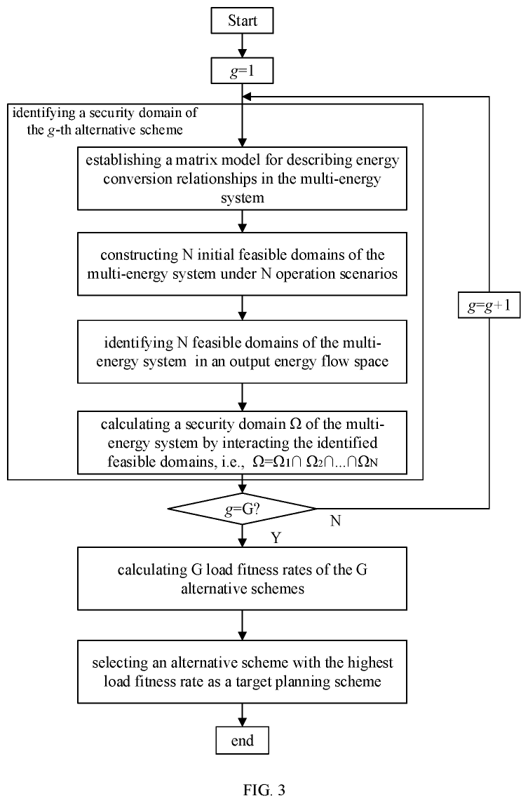

As illustrated in FIG. 3, there are G alternative schemes for planning the multi-energy system. For the g-th alternative scheme in G alternative schemes, its load fitness rate is calculated based on the g-th security region of the multi-energy system obtained at step 120. The g-th security region of the multi-energy system is marked as Ω^{g}, indicating any one scheme among all the alternative schemes obtained from the planning department, in which g is an integer equal to or greater than 1. By traversing the G alternative schemes for planning the multi-energy system, G load fitness rates may be calculated based on G security regions of the multi-energy system.

In an embodiment of the disclosure, calculating the load fitness rate of each alternative scheme may include: obtaining a load demand vector V_{δ}^{need} and an occurrence probability Pro_{δ} (δ=1, 2, . . . , Δ) of each load demand state from the multi-energy system planning department; calculating a matching degree Y_{δ,g} of each alternative scheme relative to each load demand vector Y_{δ}^{need}; and calculating the load fitness rate Fit_{g} of each alternative scheme according to Y_{δ,g}.

The multi-energy system to be planned has Δ load demand state during a planning process. The dimension of V_{δ}^{need} is Q×1 and each component of V_{δ}^{need} represents load demand of an output port.

The matching degree Y_{δ,g} of the g-th alternative scheme relative to each load demand vector V_{δ}^{need} is calculated by the following formula:

$${Y}_{δ , g} = \{ \begin{matrix}1 & {V}_{δ}^{n e e d} ∈ {Ω}^{g} \\ 0 & {V}_{δ}^{n e e d} ∉ {Ω}^{g}\end{matrix} .$$

The load fitness rate Fit_{g} of the g-th alternative scheme is calculated according to Y_{δ, g} by the following formula:

$${Fit}_{g} = {\sum }_{δ = 1}^{Δ} {Pro}_{δ} \times {Y}_{δ , g} .$$

At S140, an alternative scheme with the highest load fitness rate is selected as a target scheme for planning the multi-energy system.

In an embodiment of the disclosure, the G alternative schemes for planning the multi-energy system are traversed, step at 130 is repeated to obtain G load fitness rates, and an alternative scheme corresponding to the highest load fitness rate is selected as a planning result of the multi-energy system to be planned, thereby realizing the multi-energy system planning based on security region identification. The load fitness rate here is a value representing the fitness between load demands of output ports in the multi-energy system and the alternative scheme based on the identified security region.

The method of the present disclosure may carry out a unified and standardized modeling on the security region of the multi-energy system, in which the established optimization model is a linear model and the security region is analytical, obtain identification results of the security region of the multi-energy system in an explicit and analytical manner and apply the identification results to the multi-energy system planning, consider the security region at the planning stage of the multi-energy system (i.e., the load capacity of the multi-energy system is taken into consideration), thereby obtaining the planning results with an optimal load capacity. In summary, the planning method of the disclosure may realize the unified modeling of the security region of the multi-energy system, adopt a standardized method to identify the security region of the multi-energy system with fast calculation efficiency and high identification accuracy, and obtain analytical identification results. The identified security region may be applied to obtain the multi-energy system planning results with the optimal load capacity. The method of the present disclosure may effectively improve the reliability of the multi-energy system when supplying loads, increase the sufficiency of the multi-energy system, and reduce the occurrence probability of load shedding events.

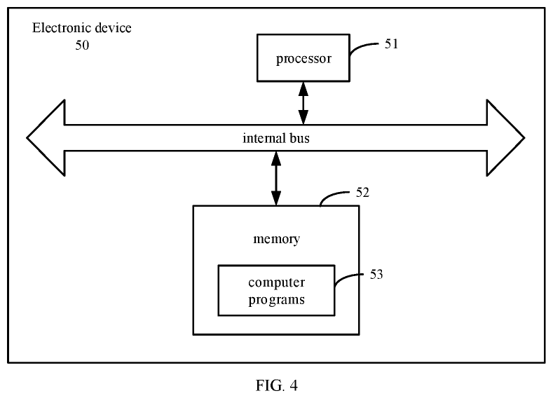

FIG. 4 is a block diagram illustrating an electronic device 50 according to an example embodiment of the disclosure. The electronic device 50 includes a processor 51 and a memory 52. The memory 52 is configured to store executable instructions. The memory 52 includes computer programs 53. The processor 51 is configured to execute blocks of the above-mentioned method.

The processor 51 is configured to execute the computer programs 53 included in the memory 52. The processor 51 may be a central processing unit (CPU) or a general-purpose processor, a digital signal processor (DSP), an application specific integrated circuit (ASIC), a field-programmable gate array (FPGA), another programmable logic device, a discrete gate, a transistor logic device, a discrete hardware component, and the like. The general-purpose processor may be a microprocessor or any conventional processor.

The memory 52 is configured to store computer programs related to the method. The memory 52 may include at least one type of storage medium. The storage medium includes a flash memory, a hard disk, a multimedia card, a card-type memory (such as, a SD (secure digital) or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. The device may cooperate with a network storage device that performs a storage function of the memory by a network connection. The memory 52 may be an internal storage unit of the device 50, such as a hard disk or a memory of the device 50. The memory 52 may also be an external storage device of the device 50, such as a plug-in hard disk, a smart media card (SMC), a secure digital (SD) card, a flash card, disposed on the device 50. Further, the memory 52 may also include both the internal storage unit of the device 50 and the external storage device. The memory 52 is configured to store the computer program 53 and other programs and data required by the device. The memory 52 may also be configured to temporarily store data that has been output or will be output.

The various embodiments described herein may be implemented by using the computer readable medium such as computer software, hardware, or any combination thereof. For a hardware implementation, embodiments described herein may be implemented by using at least one of: an application specific integrated circuit (ASIC), a digital signal processor (DSP), a digital signal processing device (DSPD), a programmable logic device (PLD), a field programmable gate array (FPGA), a processor, a controller, a microcontroller, a microprocessor, and an electronic unit designed to perform the functions described herein. For a software implementation, an implementation such as a procedure or a function may be implemented with a separate software module that allows at least one function or operation to be performed. Software codes may be implemented by a software application (or program) written in any suitable programming language, and the software codes may be stored in the memory and executed by the controller.

The electronic device 50 includes, but is not limited to, a mobile terminal, an ultra-mobile personal computer device, a server, and other electronic device with a computing function. (1) The mobile terminal is characterized by having a function of mobile communication and aiming at providing a voice and data communication. Such mobile terminal includes a smart phone (such as iPhone), a multimedia phone, a functional phone, and a low-end phone. (2) The ultra-mobile personal computer device belongs to a category of personal computer, which has a computing and processing function, and generally has a feature of mobile Internet access. Such terminal includes a PDA (personal digital assistant), a MID (mobile Internet device) and a UMPC (ultra mobile personal computer) devices, such as an iPad. (3) The server provides a computing service. A composition of the server includes a processor, a hard disk, a memory, a system bus, etc. The server is similar to the general computer architecture, but because the server only provides a highly reliable service, it requires a higher processing capacity, stability, reliability, security, scalability and manageability. (4) Other electronic device with the computing function may include, but be not limited to, the processor 51 and the memory 52. It may be understood by the skilled in the art that, FIG. 3 is merely an example of the electronic device 50, and does not constitute a limitation of the electronic device 50. The electronic device 50 may include more or less components than illustrated, some combined components, or different components. For example, the electronic device may also include an input device, an output device, a network access device, a bus, a camera device, etc.

The implementation procedure of the functions of each unit in the above device may refer to the implementation procedure of the corresponding actions in the above method, which is not elaborated here.

In some embodiment, there is also provided a storage medium including instructions, such as the memory 52 including instructions. The above instructions may be executed by the processor 51 of the electronic device 50 to perform the above method. In some embodiments, the storage medium may be a non-transitory computer readable storage medium. For example, the non-transitory computer readable storage medium may include the ROM, the random-access memory (RAM), the CD-ROM (compact disc read-only memory), a magnetic tape, a floppy disk, optical data storage device, etc.

With the above apparatus according to embodiments of the disclosure, a unified and standardized modeling is performed on the security region of the multi-energy system, the security region of the multi-energy system is identified in an explicit and analytical manner, a load fitness rate of each alternative scheme is calculated based on the identified security region, and an alternative scheme with the highest load fitness rate is selected as a target scheme, thereby obtaining the multi-energy system planning result with an optimal load capacity.

In some embodiments, there is also provided a non-transitory computer readable storage medium is provided. When instructions stored in the storage medium are executed by a processor, the processor is enabled to execute the method as described in the above embodiments.

In some embodiments, there is also provided a computer program product including executable program codes. The program codes are configured to execute any of the above embodiments of the method when executed by the above device.

In the disclosure, unless otherwise clearly specified and limited, the terms “installed”, “coupled”, “connected”, “fixed” and other terms should be understood in a broad sense, for example, it can be a fixed or detachable connection or be integrated; it can be mechanically or electrically connected; it can be directly or indirectly connected through an intermediary, it can be internal communication of two components or interaction relationship between the two components, unless specifically defined otherwise. For those skilled in the art, the specific meanings of the above-mentioned terms in the disclosure can be understood according to specific circumstances.

In the disclosure, unless expressly stipulated and defined otherwise, the first feature “on” or “under” the second feature may be the first feature in direct contact with the second feature, or the first feature in indirect contact with the second feature through an intermediary. Moreover, the first feature “over”, “above” and “up” the second feature may mean that the first feature is directly above or obliquely above the second feature, or it simply means that the level of the first feature is higher than that of the second feature. The first feature “under”, “below” and “down” the second feature may mean that the first feature is directly below or obliquely below the second feature, or it simply means that the level of the first feature is smaller than the second feature.

In the description of this specification, descriptions with reference to the terms “one embodiment”, “some embodiments”, “examples”, “specific examples”, or “some examples” etc. mean specific features, structures, materials, or characteristics described in conjunction with the embodiment or example are included in at least one embodiment or example of the disclosure. In this specification, schematic representations of the above terms do not necessarily refer to the same embodiment or example. Moreover, the described specific features, structures, materials or characteristics can be combined in any one or more embodiments or examples in a suitable manner. In addition, those skilled in the art can bind and combine the different embodiments or examples and the features of the different embodiments or examples described in this specification without contradicting each other.

Although the embodiments of the disclosure have been shown and described above, it can be understood that the above-mentioned embodiments are exemplary and should not be construed as limitations to the disclosure. Those skilled in the art can make changes, modifications, substitutions, and modifications to the above embodiments within the scope of the disclosure.

What is claimed is:

1. A method for planning a multi-energy system based on security region identification, comprising:
obtaining alternative schemes for planning the multi-energy system from a multi-energy system planning department;
for each of the alternative schemes,
establishing a matrix model for describing energy conversion relationships in the multi-energy system, in which the multi-energy system comprises N energy conversion elements, N being an integer greater than or equal to 1;
identifying N feasible domains of the multi-energy system under N operation scenarios, in which the i-th energy conversion element is out of operating under the i-th operation scenario, and
calculating a security region of the multi-energy system by intersecting the identified feasible domains under N operation scenarios;
calculating a load fitness rate of each alternative scheme based on each security region; and
selecting an alternative scheme with the highest load fitness rate as a target scheme for planning the multi-energy system.

2. The method of claim 1, wherein establishing the matrix model for describing energy conversion relationships in the multi-energy system comprises:
establishing the matrix model based on an energy conversion relationship matrix of each energy conversion element, an internal energy conversion relationship matrix of the multi-energy system, an input relationship matrix and an output relationship matrix of the multi-energy system.

3. The method of claim 2, wherein the energy conversion relationship matrix Zᵢ of the i-th energy conversion element is expressed by
Zᵢ=Hᵢ×Aᵢ(k,b),
$${A}_{i} ( k , b ) = \{ \begin{matrix}1 & an input port k of the element i connected to the branch b \\ - 1 & an output port k of the element i connected to the branch b \\ 0 & a port k of the element i disconnected to the branch b\end{matrix} ,$$
where Hᵢ represents a port energy conversion relationship matrix of the i-th energy conversion element with a dimension of Lᵢ×Kᵢ, Aᵢ(k,b) represents port-branch energy transmission relationship matrix of the i-th energy conversion element with a dimension of Kᵢ×M, and there are Lᵢ pieces of energy conversion relationships between Kᵢ ports of the i-th energy conversion element.

4. The method of claim 3, wherein the internal energy conversion relationship matrix of the multi-energy system is obtained by combining energy conversion relationship matrixes of N energy conversion elements, and is expressed by
Z=[Z₁^{T},Z₂^{T},L,Z_{N}^{T}]^{T}
where the superscript T is a matrix transposition operation.

5. The method of claim 4, wherein values in the input relationship matrix of the multi-energy system are determined by
$${C}_{in} ( p , b ) = \{ \begin{matrix}1 & if the input port p is connected to a source end of the branch b \\ 0 & otherwise\end{matrix} ,$$
and values in the output relationship matrix of the multi-energy system are determined by
$${C}_{out} ( q , b ) = \{ \begin{matrix}1 & if the output port q is connected to a source end of the branch b \\ 0 & otherwise\end{matrix} ,$$
where the port p is any one of P energy input ports in the multi-energy system, and the port q is any one of Q load output ports in the multi-energy system.

6. The method of claim 5, wherein the matrix model for describing energy conversion relationships in the multi-energy system is expressed by
ZV=0
CᵢₙV=Vᵢₙ
CₒᵤₜV=Vₒᵤₜ
where V is a state variable of the multi-energy system which represents an energy flow on a branch in the multi-energy system; Vᵢₙ represents an input energy flow of the multi-energy system; and Vₒᵤₜ represents an output energy flow of the multi-energy system.

7. The method of claim 1, identifying the feasible domains of the multi-energy system under N operation scenarios comprises:
establishing a branch feasible constraint set Φᵢ of the multi-energy system under the i-th operation scenario;
constructing an initial feasible domain Ωᵢ of the multi-energy system under the i-th operation scenario based on Φᵢ, which is expressed by
Ωᵢ={Vₒᵤₜ|CₒᵤₜV=Vₒᵤₜ,ZV=0,V∈Φᵢ};
where V represents an energy flow on a branch of the multi-energy system, Vₒᵤₜ represents an output energy flow of the multi-energy system, Z represents the energy conversion relationship matrix of the multi-energy system, and Cₒᵤₜ represents an output relationship matrix of the multi-energy system;
constructing a known feasible domain Ωᵢ′ by identifying convex polyhedron vertexes of Ωᵢ in an output energy flow space created by output energy of Q load output ports in the multi-energy system, in which a vertex X_{q}* on the q-th coordinate axis is determined by solving a linear optimization problem of:
max e_{q}^{T}X_{q}
s.t. X_{q}=CₒᵤₜV
ZV=0
V∈Φᵢ
where e_{q} is a unit direction vector of the q-th coordinate in the output energy flow space;
for the r-th surface of Ωᵢ′, calculating an optimal solution Xᵣ* by solving a linear optimization problem of
max dᵣ^{T}Xᵣ
s.t. Xᵣ=CₒᵤₜV
ZV=0
V∈Φᵢ
where dᵣ represents a unit normal vector of the r-th surface, and the superscript T is a matrix transposition operation; and
in response to Xᵣ* not belonging to Ωᵢ′, updating Xᵣ* to Ωᵢ′ and determining the updated Ωᵢ′ as the feasible domain under the i-th operation scenario, and in response to Xᵣ* belonging to Ωᵢ′, determining Ωᵢ as the feasible domain under the i-th operation scenario.

8. The method of claim 7, wherein establishing the branch feasible constraint set of the multi-energy system under the i-th operation scenario comprises:
initializing Φᵢ to be an empty set,
establishing an equation
$${\sum }_{b ∈ {E}_{{k}_{i}}} {V}_{b} = 0$$
for Kᵢ ports of the i-th energy conversion element connected to a set of branches Eₖ_{ᵢ}, where V_{b} represents an energy flow on the branch b in the multi-energy system, and adding the equation into the empty set to obtain a first set; and
establishing an in equation
$${\sum }_{b ∈ {E}_{{k}_{j}}} {V}_{b} \leq {V}_{{k}_{j}}^{max}$$
for kⱼ ports of the j-th energy conversion element (j≠i) connected to a set of branches Eₖ_{ⱼ}, where Vₖ_{ⱼ}^{max} is the maximum capacity of energy flows for the kⱼ ports in the multi-energy system, and adding the in equation into the first set, and obtaining the branch feasible constraint set Φᵢ under the i-th operation scenario by traversing all the energy conversion elements with j≠i.

9. The method of claim 1, wherein calculating the load fitness rate of each alternative scheme comprises:
obtaining a load demand vector V_{δ}^{need} and an occurrence probability Pro_{δ} (δ=1, 2, . . . , Δ) of each load demand state from the multi-energy system planning department, wherein there are Δ load demand state of the multi-energy system to be planned in total, a dimension of V_{δ}^{need} is Q×1 and each component of V_{δ}^{need} represents the load demand of an output port;
calculating a matching degree Y_{δ,g} of each alternative scheme relative to each load demand vector V_{δ}^{need b}y:
$${Y}_{δ , g} = \{ \begin{matrix}1 & {V}_{δ}^{need} ∈ {Ω}^{g} \\ 0 & {V}_{δ}^{need} ∉ {Ω}^{g}\end{matrix}$$
and
calculating the load fitness rate Fit_{g} of each alternative scheme according to Y_{δ,g}:
$${Fit}_{g} = {\sum }_{δ = 1}^{Δ} {Pro}_{δ} \times {Y}_{δ , g}$$
where Ω^{g} represents a security region of the g-th alternative scheme among the plurality of alternative schemes.

10. An apparatus for planning a multi-energy system based on security region identification, comprising:
a processor; and
a memory, having instructions stored thereon and executable by the processor;
wherein when the instructions are executed by the processor, the processor is configured to:
obtain alternative schemes for planning the multi-energy system from a multi-energy system planning department;
for each of the alternative schemes, establish a matrix model for describing energy conversion relationships in the multi-energy system, in which the multi-energy system includes N energy conversion elements, N being an integer greater than or equal to 1, identify N feasible domains of the multi-energy system under N operation scenarios, in which the i-th energy conversion element is out of operating under the i-th operation scenario, and calculate a security region of the multi-energy system by intersecting the identified feasible domains under N operation scenarios;
calculate a load fitness rate of each alternative scheme based on each security region; and
select an alternative scheme with the highest load fitness rate as a target scheme for planning the multi-energy system.

11. The apparatus of claim 10, wherein the processor is further configured to:
establish the matrix model based on an energy conversion relationship matrix of each energy conversion element, an internal energy conversion relationship matrix of the multi-energy system, an input relationship matrix and an output relationship matrix of the multi-energy system.

12. The apparatus of claim 11, wherein the energy conversion relationship matrix Z, of the i-th energy conversion element is expressed by
Zᵢ=Hᵢ×Aᵢ(k,b),
$${A}_{i} ( k , b ) = \{ \begin{matrix}1 & an input port k of the element i connected to the branch b \\ - 1 & an output port k of the element i connected to the branch b \\ 0 & a port k of the element i disconnected to the branch b\end{matrix} ,$$
where Hᵢ represents a port energy conversion relationship matrix of the i-th energy conversion element with a dimension of Lᵢ×Kᵢ, Aᵢ(k,b) represents port-branch energy transmission relationship matrix of the i-th energy conversion element with a dimension of Kᵢ×M, and there are Lᵢ pieces of energy conversion relationships between Kᵢ ports of the i-th energy conversion element.

13. The apparatus of claim 12, wherein the internal energy conversion relationship matrix of the multi-energy system is obtained by combining energy conversion relationship matrixes of N energy conversion elements, and is expressed by
Z=[Z₁^{T},Z₂^{T},L,Z_{N}^{T}]^{T}
where the superscript T is a matrix transposition operation.

14. The apparatus of claim 13, wherein values in the input relationship matrix of the multi-energy system are determined by
$${C}_{in} ( p , b ) = \{ \begin{matrix}1 & if the input port p is connected to a source end of the branch b \\ 0 & otherwise\end{matrix} ,$$
and values in the output relationship matrix of the multi-energy system are determined by
$${C}_{out} ( q , b ) = \{ \begin{matrix}1 & if the output port q is connected to a source end of the branch b \\ 0 & otherwise\end{matrix} ,$$
where the port p is any one of P energy input ports in the multi-energy system, and the port q is any one of Q load output ports in the multi-energy system.

15. The apparatus of claim 14, wherein the matrix model for describing energy conversion relationships in the multi-energy system is expressed by
ZV=0
CᵢₙV=Vᵢₙ
CₒᵤₜV=Vₒᵤₜ
where V is a state variable of the multi-energy system which represents an energy flow on a branch in the multi-energy system; Vᵢₙ represents an input energy flow of the multi-energy system; and Vₒᵤₜ represents an output energy flow of the multi-energy system.

16. The apparatus of claim 10, wherein the processor is further configured to:
establish a branch feasible constraint set Φᵢ of the multi-energy system under the i-th operation scenario;
construct an initial feasible domain Ωᵢ of the multi-energy system under the i-th operation scenario based on Φᵢ, which is expressed by
Ωᵢ={Vₒᵤₜ|CₒᵤₜV=Vₒᵤₜ,ZV=0,V∈Φᵢ};
where V represents an energy flow on a branch of the multi-energy system, Vₒᵤₜ represents an output energy flow of the multi-energy system, Z represents the energy conversion relationship matrix of the multi-energy system, and Cₒᵤₜ represents an output relationship matrix of the multi-energy system;
construct a known feasible domain Ωᵢ′ by identifying convex polyhedron vertexes of Ωᵢ in an output energy flow space created by output energy of Q load output ports in the multi-energy system, in which a vertex X_{q}* on the q-th coordinate axis is determined by solving a linear optimization problem of:
max e_{q}^{T}X_{q}
s.t. X_{q}=CₒᵤₜV
ZV=0
V∈Φᵢ
where e_{q} is a unit direction vector of the q-th coordinate in the output energy flow space;
for the r-th surface of Ωᵢ′, calculate an optimal solution Xᵣ* by solving a linear optimization problem of
max dᵣ^{T}Xᵣ
s.t. Xᵣ=CₒᵤₜV
ZV=0
V∈Φᵢ (2)
where dᵣ represents a unit normal vector of the r-th surface, and the superscript T is a matrix transposition operation; and
in response to Xᵣ* not belonging to Ωᵢ′, update Xᵣ* to Ωᵢ′ and determine the updated Ωᵢ′ as the feasible domain under the i-th operation scenario, and in response to Xᵣ* belonging to Ωᵢ′, determine Ωᵢ as the feasible domain under the i-th operation scenario.

17. The apparatus of claim 16, wherein the processor is further configured to:
initialize Φᵢ to be an empty set,
establish an equation
$${\sum }_{b ∈ {E}_{{k}_{i}}} {V}_{b} = 0$$
for Kᵢ ports of the i-th energy conversion element connected to a set of branches Eₖ_{ᵢ}, where V_{b} represents an energy flow on the branch b in the multi-energy system, and adding the equation into the empty set to obtain a first set; and
establish an in equation
$${\sum }_{b ∈ {E}_{{k}_{j}}} {V}_{b} \leq {V}_{{k}_{j}}^{max}$$
for kⱼ ports of the j-th energy conversion element (j≠i) connected to a set of branches Eₖ_{ⱼ}, where Vₖ_{ⱼ}^{max} is the maximum capacity of energy flows for the kⱼ ports in the multi-energy system, and adding the in equation into the first set, and obtaining the branch feasible constraint set Φᵢ under the i-th operation scenario by traversing all the energy conversion elements with j≠i.

18. The apparatus of claim 17, wherein the processor is further configured to:
obtain a load demand vector V_{δ}^{need} and an occurrence probability Pro_{δ} (δ=1, 2, . . . , Δ) of each load demand state from the multi-energy system planning department, wherein there are Δ load demand state of the multi-energy system to be planned in total, a dimension of V_{δ}^{need} is Q×1 and each component of V_{δ}^{need} represents the load demand of an output port;
calculate a matching degree Y_{δ,g} of each alternative scheme relative to each load demand vector V_{δ}^{need} by:
$${Y}_{δ , g} = \{ \begin{matrix}1 & {V}_{δ}^{need} ∈ {Ω}^{g} \\ 0 & {V}_{δ}^{need} ∉ {Ω}^{g}\end{matrix}$$
and
calculate the load fitness rate Fit_{g} of each alternative scheme according to Y_{δ,g}:
$${Fit}_{g} = {\sum }_{δ = 1}^{Δ} {Pro}_{δ} \times {Y}_{δ , g}$$
where Ω^{g} represents a security region of the g-th alternative scheme among the plurality of alternative schemes.

19. A non-transitory computer readable storage medium having computer instructions stored thereon, wherein the computer instructions are executed by a processor, the processor is enabled to execute a method for planning a multi-energy system based on security region identification, the method comprising:
obtaining alternative schemes for planning the multi-energy system from a multi-energy system planning department;
for each of the alternative schemes,
establishing a matrix model for describing energy conversion relationships in the multi-energy system, in which the multi-energy system comprises N energy conversion elements, N being an integer greater than or equal to 1;
identifying N feasible domains of the multi-energy system under N operation scenarios, in which the i-th energy conversion element is out of operating under the i-th operation scenario, and
calculating a security region of the multi-energy system by intersecting the identified feasible domains under N operation scenarios;
calculating a load fitness rate of each alternative scheme based on each security region; and
selecting an alternative scheme with the highest load fitness rate as a target scheme for planning the multi-energy system.

20. The storage medium of claim 19, wherein the processor is further configured to:
establish the matrix model based on an energy conversion relationship matrix of each energy conversion element, an internal energy conversion relationship matrix of the multi-energy system, an input relationship matrix and an output relationship matrix of the multi-energy system.
